(19) United States
(12) Patent Application Publication
(10) Pub. No.: US 2004/0129628 A1
(43) Pub. Date: Jul. 8, 2004

(54) Fluid filter holder

(76) Inventor: Thomas Jack McKenzie, Tucson, AZ (US)

Correspondence Address: Thomas J. McKenzie, 6230 N Camino Pimeria Alta, Tucson, AZ, 85718, US

(21) Appl. No.: 10/723,541

(22) Filed: Nov. 26, 2003

Related U.S. Application Data
(60) Provisional application No. 60/429,632, filed on Nov. 27, 2002.

(51) Int. Cl. B01D 29/00

(52) U.S. Cl. 210/455

(57) ABSTRACT

This improvement invention over the previously disclosed U.S. Pat. No. 5,468,383 issued to McKenzie Nov. 21, 1995 provides major improvements in application potential due to advanced structural integrity in the device for holding a flexible fine mesh fluid filter in a container while a fluid, such as paint, is being drawn from the container by spraying equipment. More specifically, this improvement invention provides for First Ribs 2, made of flexible material, running in a first direction and being attached to a convoluted attachment Ring 7 forming an upper chamber Area 3. Additional Ribs 5, running in the first direction combined with a plurality of Second Ribs 6, running in a transverse encirclement to the additional Ribs 5 forming a Middle Horizontal Chamber Area 4. Radian converging Vertical Ribs 9 converging from horizontal Rib 10 connecting at Support 11 to form Bottom Chamber base 8. The three chambers together form a pocket over which a fine mesh fabric fluid filter is to be positioned and held. When so assembled in use, the suction pipe of the spraying equipment is inserted into the pocket to withdraw filtered paint, or fluids as it is drawn from a container.

### CROSS REFERENCE TO RELATED APPLICATIONS

1. U.S. Provisional Application No. 60/429/632 Filed Nov. 27, 2002

### REFERENCE TO PRIOR ART

1. U.S. Pat. No. 5,468,383 McKenzie Nov. 21, 1995

### FIELD OF INVENTION

The invention primarily, but not exclusively, relates to the field of professional spraying of fluids, and more particularly to the portion of this art which involves the spraying of a fluid paint. Fluid paints are known to have particulate that require filter application to promote continuity in the powered equipment flow of the paint fluid to the desired discharging of the paint at the nozzle.

### BACKGROUND OF THE INVENTION

This invention is an improvement invention over the previously disclosed U.S. Pat. No. 5,468,383 issued to McKenzie, also inventor of this improvement invention. Normally the professional spraying of fluids, such as paint, includes motorized spray equipment which includes a pump for drawing paint through a pipe directly from a container, such as a bucket, and spraying the paint through a spray head, such as a nozzle, having a very small opening, through which the paint is sprayed upon whatever it is to be received.

However, in use it usually isn't long before enough of the particle impediments find their way through the pipe and clog the nozzle, requiring a shut down of the spraying equipment to clean the nozzle, resulting in some undesirable lost time on the job. In the past some efforts have been made to prevent this clogging of the spraying equipment, such as first pouring the paint into containers through a large fine mesh fabric filter, but this takes an unduly long time, resulting in lost time on the job.

### SUMMARY OF THE INVENTION

This improvement invention over the previously disclosed U.S. Pat. No. 5,468,383 issued to McKenzie, provides an unbelievably simple and inexpensive “device for holding” a flexible fine mesh fabric filter, usually of Nylon, over the end of the spraying equipment suction pipe when they are position at the bottom of the container, thus permitting the paint, or other fluids, to be successfully filtered through the Nylon filter as it is drawn from the container to be sprayed from the associated nozzle without clogging the nozzle, thus permitting the spraying job to be completed without the delays formerly associated with professional spraying equipment.

### BRIEF DESCRIPTION OF THE DRAWINGS

FIG. 1 shows a vertical plan view of the Fluid Filter Holder Device 1.

FIG. 2 shows a plan view of a Convoluted Attachment Ring 7.

FIG. 3 shows a plan view of the Chamber Base 8.

### DETAILED DESCRIPTION OF THE INVENTION

The subject of this invention is a Fluid Filter Holder device made of satisfactory flexible material, of plastic or, such as rubber of a type which would have sufficient resistence to flexing as to retain its shape during use, but flexible enough to be expanded open to permit a suction pipe to be inserted through the opening 12 and extend to the bottom chamber Base 8 and be supported on Support 11 and Vertical Ribs 9.

Actually, before the filter holder of the present invention is placed in a container of liquid, a very fine mesh fabric filter (usually of Nylon) is slipped over the holder and tightly expanded to its fully open condition by Ribs 2, 5, 6, 8, 9 and 10. This prevents any portion of the (Nylon) filter being sucked into contact with the suction pipe to obstruct the full flow of fluid through itself, making the filter holder invention provide a filter system adaptable and useful in most existing professional fluid spraying equipment currently in use, and one which fully satisfies the purpose of the invention.

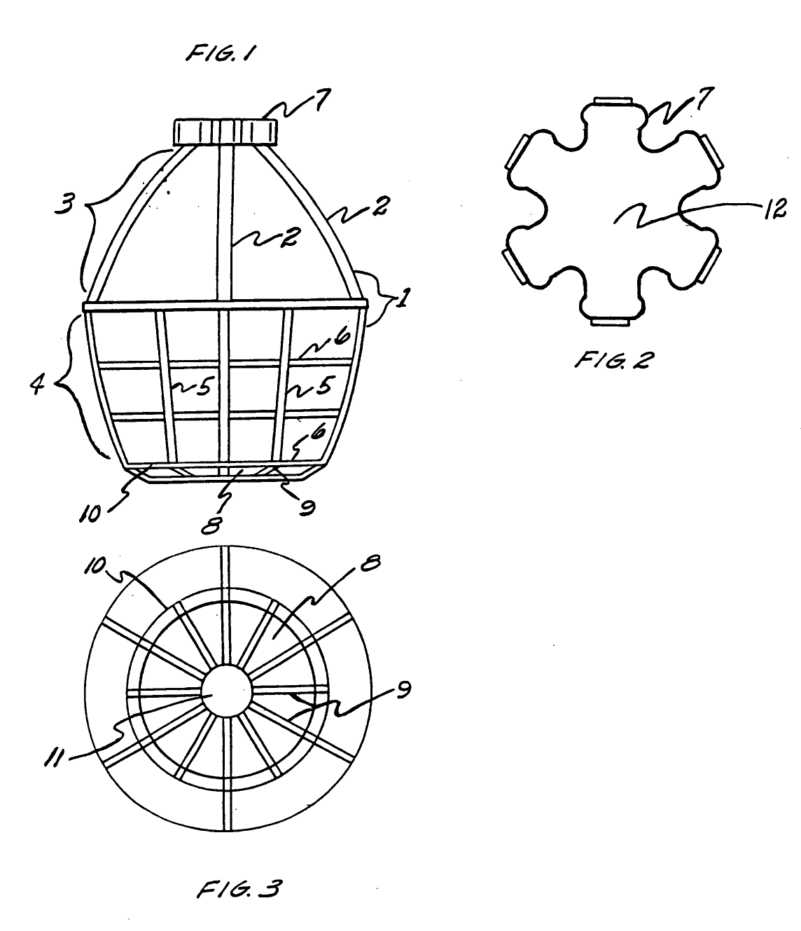

As shown in FIG. 1, a vertical plan view, the Fluid Filter Holder device 1, is comprised of a plurality of First Ribs 2, in a first direction defining an Upper Chamber area 3. The Middle Chamber area 4, has Additional Ribs 5, in the first direction combined with a plurality of Second ribs 6, running in a transverse encirclement to the first ribs for added reinforcement. The result is a structurally sound device that provides the following fluid flow advantages:

The Upper Chamber area 3, resists deformation from the vertical gravity force of the liquid. This allows increased downward gravity flow of the liquid through the strainer. The Middle Horizontal Chamber area 4, is likewise resistant to deforming or collapse even with high volume pump action. This resistance to deformation allows a desired flow rate to be continuous.

FIG. 2, presents a top plan view of a convoluted Attachment Ring 7 (a form of the spring ring found in U.S. Pat. No. 5,468,383 McKenzie, shown here for illustration only, and, with “no claims” being made in this patent application for the Attachment Ring), that can be expanded or contracted to provide proper fit to the various sized pick-up tubes found on different fluid pumps. FIG. 3, is a bottom plan view of the Chamber Base 8. This shows the radian convergence 9, of the vertical ribs just below the bottom horizontal rib 10. This again provides a non-deforming structure and in addition it provides a necessary protective support 11, for the pick-up tube of the fluid pump.

This invention provides major improvements in application potential due to the advanced structural integrity that allows the device to be placed within fluid containers and provide an increase in continuous flow volume of filtered fluid without potential for failure caused by deforming or collapse.

Omitting the specific dimensions of this invention as being unnecessary to a clear understanding thereof, the description in the immediately above paragraphs describes the complete invention in its best and preferred form as it will be used to hold a fine mesh fabric filter (usually of Nylon) to successfully filter particles and foreign objects from liquids to be pumped, sprayed, or both.

What is claimed is:

1. A Fluid Filter Holder for use with fluid spraying equipment comprising a suction pipe connected through a pump to a fluid spraying nozzle:
A fluid filter holder comprising a plurality of first ribs running in a first direction and defining a chamber and a plurality of second ribs running transverse to the said first ribs to reinforce.

2. A Fluid Filter Holder according to claim 1 wherein:
Said ribs are formed of flexible material, of plastic or rubber, whereby upper portion of first direction ribs may be expanded.

3. A Fluid Filter holder according to claim 1 wherein:
Said Second Ribs running transverse to the said first ribs reinforce to prevent collapse by suction of pump action.

4. A Fluid Filter Holder for use with fluid spraying equipment comprising a suction pipe connected through a pump to a fluid spraying nozzle:
A Fluid Filter Holder configurated to resist gravity forces, creating increased flow of fluid through the fluid filter being held by the fluid filter holder.

5. A Fluid Filter Holder for use with fluid spraying equipment comprising a suction pipe connected through a pump to a fluid spraying nozzle:
A fluid filter holder having a chamber base formed by radial convergence vertical ribs into horizontal ribs.

6. A Fluid Filter Holder according to claim 5 wherein:
Said radial convergence vertical ribs into horizontal ribs forms a resting support for the end of the suction pipe while preventing said suction pipe from coming in contact with the filter being held by the filter holder.
